(19) United States
(12) Patent Application Publication
(10) Pub. No.: US 2008/0231439 A1
(43) Pub. Date: Sep. 25, 2008

(54) Activity Detection Circuit for a Storage Device

(75) Inventor: Chun-Yi Wu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Inventec Corporation, Taipei City (TW)

(21) Appl. No.: 11/689,731

(22) Filed: Mar. 22, 2007

(51) Int. Cl. G08B 21/00

(52) U.S. Cl. 340/540

(57) ABSTRACT

An activity detection circuit for a storage device including a sampling module, a logic module, and an indication module. The sampling module is for detecting a state interface of the storage device by a reference signal. The logic module is for determining a state of the storage device according to a detection result generated by the sampling module. The indication module includes a light emitting device, wherein when the storage device is in a connected state, the light emitting device emits constant light, and when the storage device is in a read/write state, the light emitting device emits flickering light. The present invention also provides a storage module including a storage device, a connection port and the activity detection circuit described above.

### BACKGROUND

1. Field of Invention

The present invention relates to an activity detection circuit. More particularly, the present invention relates to an activity detection circuit for a storage device.

2. Description of Related Art

As technology advances, the market for electronics products also is on the rise and people's need for information is also on the rise. This leads to the continuous upgrades in computer system performance along with the ever-improving software. Therefore, whether it is the operation system or gaming software, they both require large memory space for data storage. Generally speaking, most data is stored in the hard drive, making the hard drive a key component of the computer equipment.

In general, a storage device such as a hard drive is connected to the computer system through a hard drive connection port. The connection port is connected to an indication light on the computer system, in which the operation status is known through the lighting of the indication light. For example, the serial attached SCSI (SAS) hard drive and the serial advanced technology attachment (SATA) hard drive drive the indicator light by outputting signals through pin 11 of the connection port, wherein when pin 11 outputs a low voltage, the indication light is turned on, when pin 11 outputs a high voltage, the indication light is turned off, and when pin 11 outputs an alternating high/low voltage, the indicator light is flickering on and off.

Furthermore, the SAS hard drive connection port may be electrically connected to the same type of hard drive (SAS hard drive) or to a SATA hard drive. Please refer to FIG. 1, when the SATA hard drive is connected to the SAS connection port, pin 11 will output a high voltage signal such as in a hard drive state 101. If the computer system is reading/writing to the SATA hard drive, then the signal at pin 11, while in the read/write state 103, will be a toggling signal such as the state signal 111. However, when the SATA hard drive is in a connected state 101, yet is non-read/write state 105, the state signal 111 at pin 11 will be a high voltage, making the indication light state 121 to be off, thus the user will not able to recognize whether if the hard drive is connected or if it is connected but not reading and writing. This is likely to mislead the user to believe that the storage device is not connected properly and thus repeatedly reconnect the storage device and the connection port causing possible damages.

For the forgoing reasons, there is a need for an activity detection circuit, which may correct the problem of the conventional indication light unable to indicate the correct state of the storage device connection with the motherboard.

### SUMMARY

The present invention is directed to an activity detection circuit, that it satisfies this need of detecting the activity of a storage device. The activity detection circuit comprises a sampling module, a logic module and an indication module. The sampling module is for detecting a state interface of the storage device by a reference signal and generates a detection result. The logic module is for determining the state of the storage device based on the detection result. The indication module, namely a light emitting device, is for indicating the state of the storage device to the user such that when the storage device is in a connected state, the light emitting device emits a constant light, and when the storage device is in a read/write state, the light emitting device emits a flickering light. The storage device may be a hard drive such as a SATA hard drive connected to a connection port such as a SAS connection port. When the sampling module such as a shift register detects the state interface such as pin 11 of the storage device, the shift register outputs a state signal depending on the connection state of the hard drive. If the hard drive is connected to the connection port but not in the read/write state, the logic module such as a AND gate will output a logic high. The logic high provides a fixed voltage difference to the indication module and thus turns on the indication module such as a light emitting diode (LED). On the contrary, when the shift register detects activity (reading/writing) in the hard drive, the AND gate will output a logic low. The logic low provides a varying voltage difference to the LED causing the LED to flicker on and off.

From the above logic sequence, the user is aware of the connection status of the storage device and also the activity status of the storage device. Therefore eliminating the unknown connection status in the prior art and preventing the user from potentially damaging the storage device by repeatedly reconnecting the storage device to the connection port.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a signal diagram of a conventional activity detection circuit for a storage device;

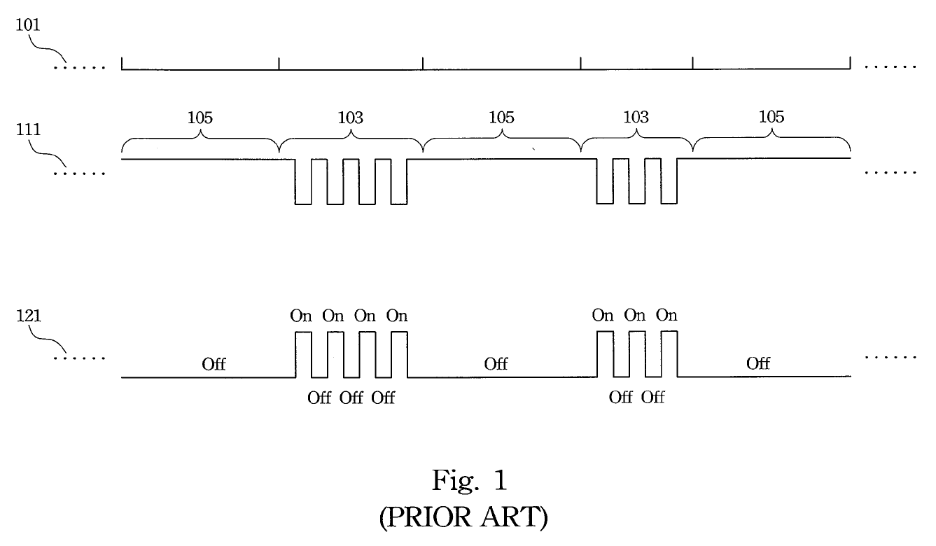

FIG. 2 is a system block diagram according to an embodiment of the present invention;

FIG. 3 is a circuit diagram of the activity detection circuit according to the embodiment of the present invention; and

FIG. 4 is an exemplary signal diagram of the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

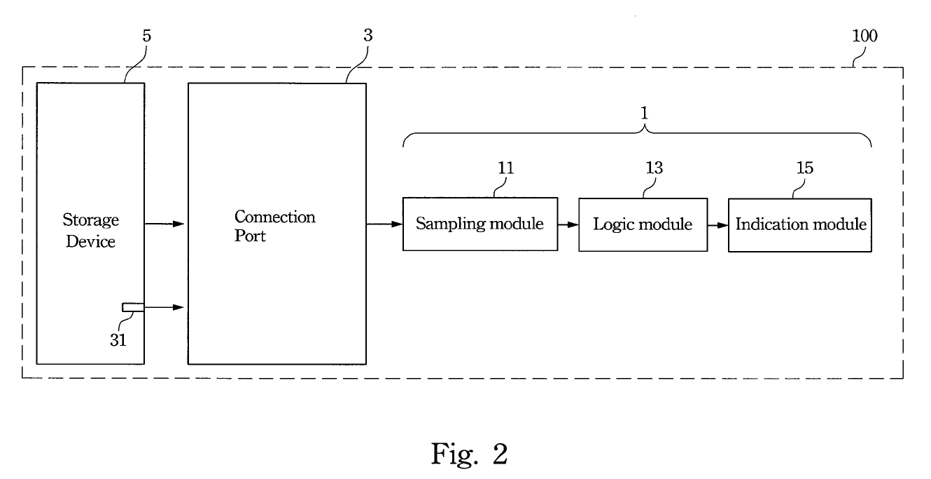

Please refer to FIG. 2, a system block diagram of an embodiment of the present invention. The storage module 100 includes an activity detection circuit 1, a connection port 3, and a storage device 5. The activity detection circuit 1 is electrically connected to the connection port 3. The connection port is electrically connected to the storage device 5, such as a hard drive, more specifically, a SATA hard drive. The activity detection circuit 1 includes a sampling module 11, a logic module 13, and an indication module 15. The input of the sampling module 11 is electrically connected to the connection port 3. The state interface 31, namely pin 11 of the storage device 5, carries a state signal indicative of the state of the storage device 5. The state interface 31 of the storage device 5 is connected to the motherboard of the computer system though the connection port 3 and may be electrically routed to other pins on the motherboard. Therefore, the physical connection between state interface 31 and the sampling module 11 through the connection port 3 may be an extension pin on the motherboard. The outputs of the sampling module 11 are electrically connected to the inputs of the logic module 13, and the output of the logic module 13 determines the output of the indication module 15. For example, the storage device 5 may be a SATA hard drive electrically connected to a SAS connection port 3.

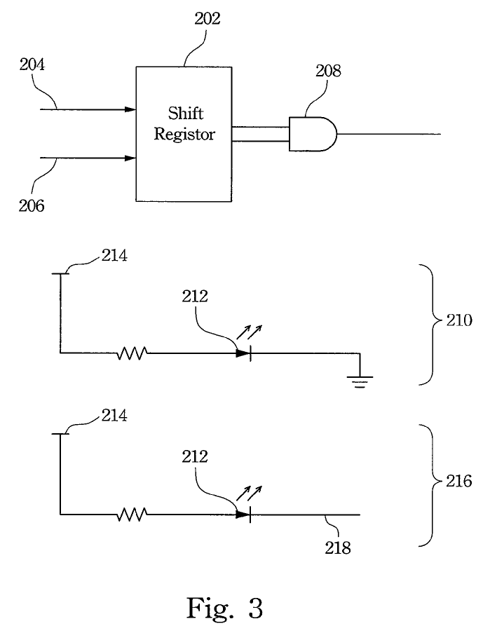

Please refer to FIG. 3, a circuit diagram of the activity detection circuit 1 according to the embodiment of the present invention. In this embodiment, the sampling module 11 may be a sample-and-hold circuit, such as a shift register, which detects the state signal 204 from the state interface by a reference signal 206; for example, the reference signal may be a clock signal with a predetermined frequency. The detection result is received by the logic module 13. The logic module 13 then processes the detection result and outputs a logic state (high or low) to drive the indication module 15. In this case, the logic module 13 may be a logic gate, a combinational logic circuit, a programmable logic circuit, or a combination thereof. For example, an AND gate 208 may serve as the logic module 13. When the AND gate outputs a logic high 210, representing the storage device 5 is connected to the motherboard (not shown), the indication module such as a LED 212 will experience a fixed voltage such as the potential difference between a power source 214 and ground driving the LED 212 to emit a constant light. When the AND gate outputs a logic low 216, the LED 212 will experience a varying voltage such as a voltage 218 toggling from the voltage at the power source 214 and ground driving the LED 212 to emit a flickering light.

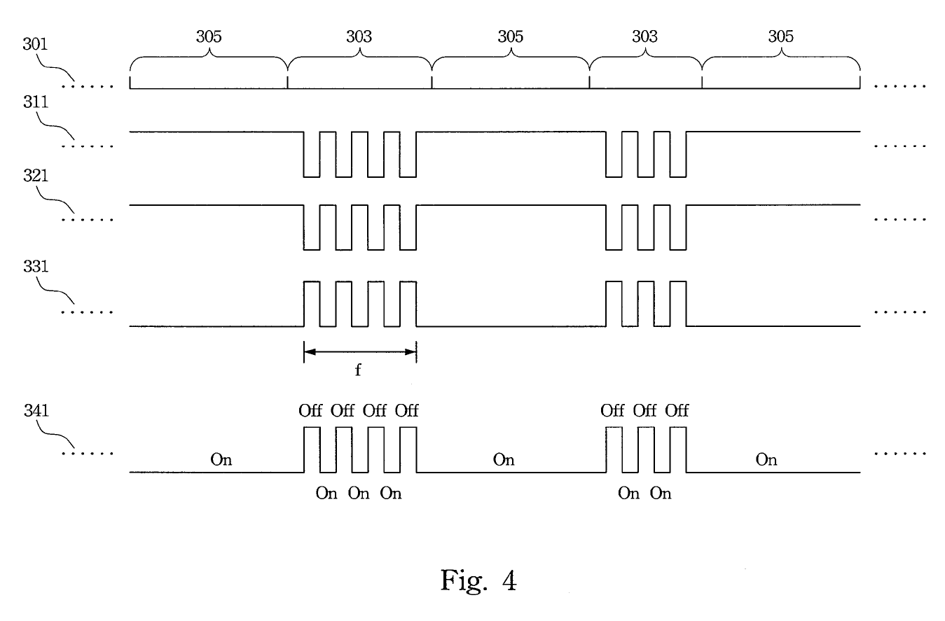

Please refer to FIG. 4, an exemplary signal diagram of the embodiment of the present invention. In this diagram, the hard drive is connected to the motherboard through the connection port. The hard drive activity state 301 is classified into two states: read/write state 303 and connected state 305. As seem in the diagram, the hard drive activity state 301 is alternating between the read/write state 303 and the connected state 305. When the hard drive is in the connected state 305, the hard drive is not reading and writing and the state signal 311 is at a constant logic high. Therefore, when the sample module samples a constant logic high at a predetermined frequency, the sampling module outputs a detection result of logic high. The detection result of logic high is inputted into the logic module and since the logic module is an AND gate, the output of the logic module 321 is a logic high. The output 321 of the logic module then allows the indication module to experience a voltage 331, which in the connected state 305 is a fixed voltage. When the voltage 331 is fixed, the indication module such as a LED is in constant forward bias, and thus the indication module state 341 is constantly on. Next, when the hard drive activity state 301 is in the read/write state 303, the state signal 311 will be a toggling signal, toggling between a logic high and logic low. The sampling module reads the toggling signal at the predetermined frequency, and outputs a detection result including both logic low and logic high. The set of logic low and logic high will lead to the output 321 of the logic module being a logic low (AND gate operation). The output logic low then allows the indication module to experience a voltage 331, which in the read/write state 305 is a varying voltage. When the voltage 331 is varying, the LED will flicker on and off according to the varying voltage 331.

Therefore, the activity detection circuit for a storage device is able to inform the user when the storage device is connected with the connection drive (LED constantly on), and when the storage device is connected, reading and writing (LED flickering on and off). The user will no longer be prone to repeatedly reconnect the storage device to the connection port due to unawareness of the state of the storage device connection and activity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An activity detection circuit for a storage device, comprising:
a sampling module for detecting a state interface of the storage device by a reference signal;
a logic module for determining a state of the storage device according to a detection result generated by the sampling module; and
an indication module comprising a light emitting device, wherein when the storage device is in a connected state, the light emitting device emits constant light, and when the storage device is in a read/write state, the light emitting device emits flickering light.

2. The activity detection circuit of claim 1, wherein the sampling module is a sample-and-hold circuit.

3. The activity detection circuit of claim 2, wherein the sample-and-hold circuit comprises a shift register.

4. The activity detection circuit of claim 1, wherein the reference signal is a clock signal having a predetermined frequency.

5. The activity detection circuit of claim 1, wherein the logic module is a logic gate, a combinational logic circuit, a programmable logic circuit, or a combination thereof.

6. The activity detection circuit of claim 1, wherein the logic module generates a logic level indicative of the state of the storage device.

7. The activity detection circuit of claim of claim 6, wherein when the logic level is high, the light emitting device experiences a fixed voltage to emit constant light, and when the logic level is low, the light emitting device experiences a varying voltage to emit flickering light.

8. The activity detection circuit of claim 1, wherein the light emitting device comprises a light emitting diode (LED).

9. A storage module, comprising:
a storage device;
a connection port for connecting the storage media to a computer system, the connection port having a state interface electrically connected to the storage device; and
an activity detection circuit, comprising:
a sampling module for detecting the state interface by a reference signal;
a logic module for determining a state of the storage device according to a detection result generated by the sampling module; and
an indication module comprising a light emitting device, wherein when the storage device is connected to the computer system, the light emitting device emits constant light, and when the storage device is reading and writing, the light emitting device emits flickering light.

10. The storage module of claim 9, wherein the storage device is a hard drive.

11. The storage module of claim 9, wherein the connection port is a serial attached SCSI (SAS) connection port or a serial advanced technology attachment (SATA) connection port.

12. The storage module of claim 9, wherein the sampling module is a sample-and-hold circuit.

13. The storage module of claim 12, wherein the sample-and-hold circuit comprises a shift register.

14. The storage module of claim 9, wherein the reference signal is a clock signal having a predetermined frequency.

15. The storage module of claim 9, wherein the logic module is a logic gate, a combinational logic circuit, a programmable logic circuit, or a combination thereof.

16. The storage module of claim 9, wherein the logic module generates a logic level indicative of the state of the storage device.

17. The storage module of claim of claim 16, wherein when the logic level is high, the light emitting device experiences a fixed voltage to emit constant light, and when the logic level is low, the light emitting device experiences a varying voltage to emit flickering light.

18. The storage module of claim 9, wherein the light emitting device comprises a light emitting diode (LED).
